(19) United States
(12) Patent Application Publication
(10) Pub. No.: US 2007/0122321 A1
(43) Pub. Date: May 31, 2007

(54) Reactor enabling residence time regulation

(76) Inventors: Lee David Proctor, Denbighshire (GB); Anthony John Warr, Chester (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/557,075

(22) PCT Filed: Apr. 26, 2004
(86) PCT No.: PCT/GB04/01763

§ 371 Date: Nov. 17, 2005

(30) Foreign Application Priority Data
May 19, 2003 (GB) 0311459.2

(51) Int. Cl. B01J 8/04

(52) U.S. Cl. 422/188

(57) ABSTRACT

The present invention relates to a reactor comprising a plurality of reaction zones, a first reaction zone being configured to provide a first residence time for a reaction mixture passing therethrough at a particular flow rate, and a second reaction zone connected in series with the first reaction zone and configured to provide a second residence time for the reaction mixture passing therethrough at the particular flow rate, wherein the second residence time is at least about 1.5 times greater than the first residence time, the reactor further comprising means for bypassing at least one of the first and second reaction zones to reduce the effective residence time of the reaction mixture passing through the reactor.

The present invention relates to a variable residence time reactor, in particular to a variable residence time reactor suited for continuous operation.

Various types of reactor for carrying out chemical and biological reactions are currently available which work either on a batch or continuous operation system. Hybrids of the two systems can also be found. The residence time of a reaction mixture in a batch operation reactor can be varied simply by controlling the start and end times of the reaction. In contrast, the residence time of a reaction mixture in a continuous operation reactor tends to be controlled by the flow rate through the reactor, control of which is only possible within certain limits without adversely affecting process kinetics and other fundamentals of the process reaction. Since it is desirable in many cases to conduct chemical or biological reactions on a continuous basis, it would be useful to provide a greater degree of control over the residence time in continuous operation than has hitherto been the case. A number of reactors directed towards a continuous operation system have been disclosed which utilise modular components, whereby the reactor apparatus can be altered in order to optimize reaction conditions and/or to allow for the reactor to be modified in order to be used for a different reaction. This also presents the problem of having an apparatus which is time consuming to modify and expensive to purchase due to its requirement of a number of components which may not be used at any one given time.

U.K. Patent Application No. GB841416 discloses improvements in or relating to apparatus for carrying out chemical reactions by means of a cascade system. The apparatus comprises a closed reaction vessel, an inlet means for reactants at the top of the vessel, an opening at the top of the vessel for removal of vapors therefrom, the vessel incorporating a plurality of compartments through which the reactants can flow successively. A common problem with such a reactor apparatus is that the apparatus will be designed with a certain reaction or reaction type in mind and thus be limited in scope. Furthermore, such apparatus may not be suitable for certain types of continuous liquid reaction which require equal residence time for the reaction to proceed precisely and in this connection, apparatus based upon flow tubes are therefore favored.

U.S. Pat. No. 5,580,523 discloses a modular reactor system and method for synthesising chemical compounds. The apparatus includes a number of generic components such as pumps, flow channels, manifolds, flow restrictors, and valves. The modular reactors, separator and analyzers that are on an assembly board allow for a system where a modular reactor unit has an I.D. of up to 100 μm to optimize control of residence time within a reaction zone. Although this reactor system appears to address the inherent problems associated with bespoke reactor vessels, namely that the system is adaptable for a number of different reactions, it can be time consuming to alter the various components in order to set up the apparatus for a different reaction. Furthermore, such modular systems can lead to a large number of components not being used at any one given time, or a delay in configuring the apparatus whilst the extra components are ordered and delivered.

International Patent Application No. WO 02/072254 discloses a reactor apparatus directed towards efficient heat transfer comprising an assembly of a plurality of separate conduits, each conduit defining a one or more flow paths through the reactor, the length of each capable of being varied by adjusting the number of conduits connected such that the residence time of reactants flowing in the or each flow path can be varied. This apparatus relies on the physical movement and reconfiguration of connectors in order to alter the conditions of a given reaction, such as residence time and heat transfer. This in itself leads to problems, as it is time consuming to set up the apparatus. Difficulties also arise in optimizing the reaction conditions, as a chemist will have to set up the apparatus again with the new settings and furthermore such manual configuration can lead to damage to the apparatus (for example to the couplings), which could be expensive to rectify and possibly dangerous depending on the reaction (for example a high temperature reaction involving a toxic compound).

It is an object of the present invention to overcome one or more of the problems associated with the prior art reactor apparatus. In addition, it is also an object of the present invention to provide a reactor apparatus which is easily adaptable to a number of reactions and particularly adaptable to vary the residence time of the reactor. Therefore, it is an object of the invention to provide a reactor which can respond to scale-up demands and other operating variables from time to time, preferably on-line (without requiring shut down of the reactor).

In accordance with the present invention, there is provided a reactor comprising a plurality of reaction zones, a first reaction zone being configured to provide a first residence time for a reaction mixture passing therethrough at a particular flow rate, and a second reaction zone connected in series with the first reaction zone and configured to provide a second residence time for the reaction mixture passing therethrough at the particular flow rate, wherein the second residence time is at least about 1.5 times greater than the first residence time, the reactor further comprising means for bypassing at least one of the first and second reaction zones to reduce the effective residence time of the reaction mixture passing through the reactor.

Preferably the second residence time is at least about 2 times greater than the first residence time.

The reactor may comprise a third reaction zone connected in series with the second reaction zone and configured to provide a third residence time for the reaction mixture passing therethrough at the particular flow rate, wherein the third residence time is at least about 1.5 times greater than the second residence time. In this case, the reactor may further comprise means for bypassing the third reaction zone to reduce the effective residence time of the reaction mixture passing through the reactor. Preferably the third residence time is at least about 2 times greater than the second residence time.

The reactor may comprise a fourth reaction zone connected in series with the third reaction zone and configured to provide a fourth residence time for the reaction mixture passing therethrough at the particular flow rate, wherein the fourth residence time is at least about 1.5 times greater than the third residence time. In this case, the reactor may further comprise means for bypassing the fourth reaction zone to reduce the effective residence time of the reaction mixture passing through the reactor. Preferably the fourth residence time is at least about 2 times greater than the third residence time.

The reactor may comprise an nth reaction zone connected in series with an (n−1)th reaction zone and configured to provide an nth residence time for the reaction mixture passing therethrough at the particular flow rate, wherein the nth residence time is at least about 1.5 times greater than the (n−1)th residence time. In this case, the reactor may further comprise means for bypassing the nth reaction zone to reduce the effective residence time of the reaction mixture passing through the reactor. Preferably the nth residence time is at least about 2 times greater than the (n−1)th residence time.

Preferably, when a reaction zone is bypassed, the series connection between the or a preceding reaction zone and the or a following reaction zone is maintained. Also preferably, when a one or more reaction zones are bypassed, the series connection between the remaining (unbypassed) reaction zones is maintained.

The reactor of the invention therefore permits close control of the residence time for a particular reaction mixture flowing therethrough by suitable bypassing of none, one or more reaction zones. Thus, in a reactor according to the invention which has three reaction zones, respectively configured to provide a residence time of 10 seconds, 20 seconds and 40 seconds, for a particular flow rate, the operator of the reactor can readily adjust the desired residence time. Thus, by bypassing the second and third reaction zones, a residence time of 10 seconds can be provided. By bypassing the first and third reaction zones, a residence time of 20 seconds can be provided. By bypassing only the third reaction zone, a residence time of 30 seconds can be provided. By bypassing the first and second reaction zones, a residence time of 40 seconds can be provided. By bypassing only the second reaction zone, a residence time of 50 seconds can be provided. By bypassing only the first reaction zone, a residence time of 60 seconds can be provided. By bypassing none of the reaction zones, a residence time of 70 seconds can be provided. Clearly, the range of selectable residence times will increase with the number of reaction zones.

Preferably, each reaction zone in the reactor, or in a reactor section corresponding to the invention, is configured to provide a residence time which is longer than that provided by a preceding reaction zone by a factor of x, which is at least about 1.5, preferably at least about 2, but may be larger and may be the same or different between different pairs of reaction zones.

One convenient means for bypassing a particular reaction zone comprises a switchable valve situated upstream of the reaction zone inlet. The valve has an inlet for incoming reaction mixture, but two outlets and means for switching flow through the valve between the two outlets. When a first outlet is selected, incoming reaction mixture flows through the valve and into the reaction zone inlet. When a second outlet is selected, incoming reaction mixture flows through the valve and into a bypass region, avoiding the reaction zone. Preferably a second switchable valve is situated downstream of the reaction zone outlet. This second valve has an outlet for outgoing reaction mixture, but two inlets and means for switching flow through the valve between the two inlets. When the reaction zone is not bypassed, this valve is switched to receive reaction mixture from the reaction zone outlet. When the reaction zone is bypassed, this valve is switched to receive reaction mixture from the bypass region.

The configuration of each reaction zone to provide different residence times may be effected by, for example, the bore of reaction tubing within each reaction zone,. by the length of such tubing, or by both. Thus, in one preferred embodiment of the invention, each reaction zone beyond the first reaction zone comprises tubing inside which a chemical or biological reaction takes place in use of the reactor, the tubing bore being larger than the tubing bore in an immediately preceding reaction zone. In another preferred embodiment of the invention, each reaction zone beyond the first reaction zone comprises tubing inside which a chemical or biological reaction takes place in use of the reactor, the tubing length being larger than the tubing length in an immediately preceding reaction zone. Other means of effecting different residence times in different reaction zones, such as by using different numbers, shapes and/or sizes of units in each respective reaction zone, will. be apparent to the skilled person.

The number of reaction zones the reaction mixture flows through and/or by-passes can be varied to provide a desired residence time in the reactor. Preferably, the number of reaction zones the reaction mixture flows through and/or by-passes is determined by the residence time required for a given reaction to take place. This will be of particular benefit to the pharmaceutical industry, where residence time often determines characteristics of the compound being produced, such as the enantiomeric excess and yield for example.

The apparatus may also have one or more monitoring devices disposed within the apparatus for monitoring reaction conditions and/or apparatus status. Preferably, the apparatus has a processing device for processing information from a monitoring device. The apparatus may also have a control device for controlling the apparatus. More preferably, the apparatus may have a processing device that can automatically adjust the apparatus to optimize reaction conditions. Therefore, such an apparatus as herein described above may be linked to a computer or similar processing device for a number of applications such as automatically optimizing the reaction conditions (such as residency time) by allowing the reaction mixture to flow through or by-pass any given vessel and control one or more pumps to regulate the reaction mixture velocity. Such a processing device may also be used for validating the resulting composition or the starting reagents for the reaction

A specific embodiment of the present invention will now be described, by way of example only, with reference to the accompanying drawing.

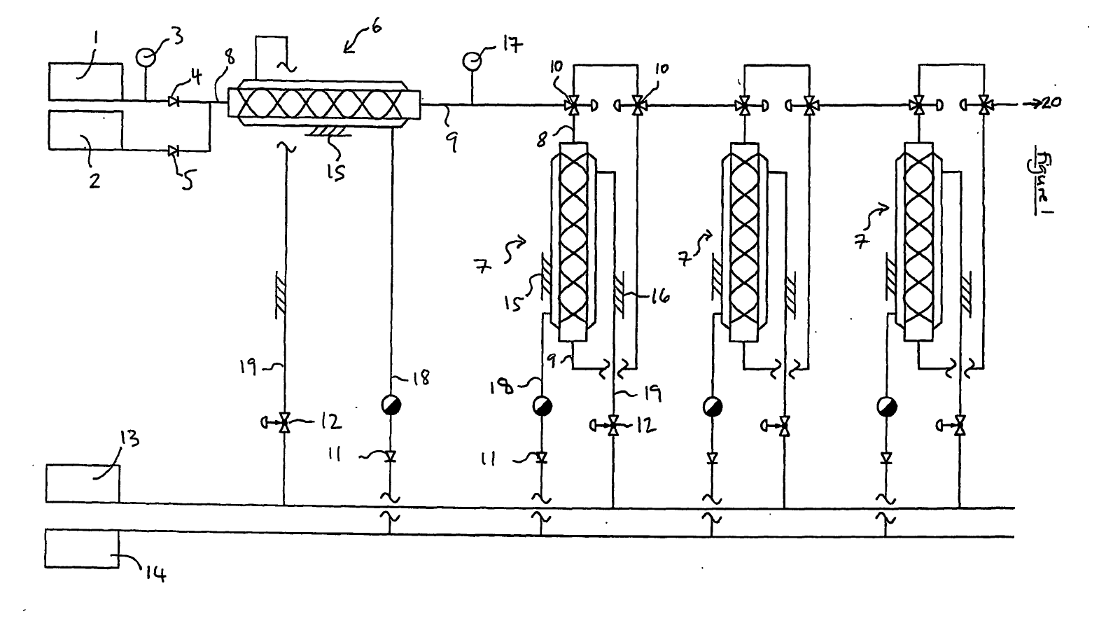

FIG. 1, illustrates a plan of a reactor apparatus.

Referring to FIG. 1, there is shown a simplified flow diagram for continuous operation of a chemical or biological reaction. FIG. 1 shows first reaction zone 1 connected in series with second, third, fourth, fifth and sixth reaction zones 2 to 6 respectively. In FIG. 1 each reaction zone is shown as a shell and tube reactor, although it will be understood that other types of reactor design may be utilised in utilised in accordance with the invention.

Reaction zone 1 comprises a reactor shell and, inside the shell, a plurality of reaction tubes inside which a chemical or biological reaction takes place in use of the reactor. Reaction zone 1 is heated by means of heating jacket 7 supplied in line 8 with steam, with cooled steam or condensate returning in line 9. Reaction zones 2 to 6 are similarly configured.

Reaction zone 2 is provided with reaction tubes which are approximately twice the diameter of the tubes in reaction zone 1, thereby giving rise to an effective residence time (for a reaction mixture flowing at the same rate through reaction zones 1 and 2) in reaction zone 2 of approximately twice that of reaction zone 1. The bore of the reaction tubes in reaction zone 3 is, similarly twice that of those in reaction zone 2, and this progression of increasing reaction tube bores and, thus, increasing residence times, is continued through remaining reaction zones 3 to 6.

When all of the reaction zones are employed, a reaction mixtures passes into reaction zone I in line 10 and progressing through reaction zone 1 and on in line 11 to switchable inlet valve 12 immediately upstream of the inlet of reaction zone 2. The reaction mixture entering valve 12 is directed into reaction zone 2 and then on line 13 to switchable valve 14 immediately downstream of the outlet of reaction zone 2. The reaction mixture passes into valve 14 and progresses on in line 15 towards switchable valve 16 provided directly upstream of the inlet to reaction zone 3. The reaction mixture proceeds in this fashion through each of the reaction zones.

However, if, say, the third reaction zone is by passed then switchable valve 16 is altered so that reaction mixture enters from line 15 but then exits into by pass region 17. Switchable valve 18 immediately downstream of the outlet of reaction zone 3 is also switched to receive incoming reaction mixture from by pass region 17, which reaction mixture then passes on in line 19 towards switchable valve 20 provided immediately upstream of the inlet of reaction zone 4. It will be appreciated that it is readily possible to by pass any one, or more than one, of reaction zones 2 to 6. When a particular zone is by passed the flow of reaction mixture continues through any by pass reaction zone. In this way, it is possible for the operator of the reactor to select with a close degree of control a particular desired residence time for a reaction proceeding on a continuous basis through the reactor.

It will be appreciated that the configuration of plant, pipework, control valves, pumps, release valves, flow controllers and other items of standard equipment shown are illustrated by way of example only, and that the reactor of the invention is not limited to the configurations shown in FIG. 1.

1. A reactor comprising a plurality of reaction zones, a first reaction zone being configured to provide a first residence time for a reaction mixture passing therethrough at a particular flow rate, and a second reaction zone connected in series with the first reaction zone and configured to provide a second residence time for the reaction mixture passing therethrough at the particular flow rate, wherein the second residence time is at least about 1.5 times greater than the first residence time, the reactor further comprising means for bypassing at least one of the first and second reaction zones to reduce the effective residence time of the reaction mixture passing through the reactor.

2. A reactor according to claim 1 wherein the second residence time is at least about 2 times greater than the first residence time.

3. A reactor according to claim 1 comprising a third reaction zone connected in series with the second reaction zone and configured to provide a third residence time for the reaction mixture passing therethrough at the particular flow rate, wherein the third residence time is at least about 1.5 times greater than the second residence time.

4. A reactor according to claim 3 further comprising means for bypassing the third reaction zone to reduce the effective residence time of the reaction mixture passing through the reactor.

5. A reactor according to claim 3 wherein the third residence time is at least about 2 times greater than the second residence time.

6. A reactor according to claim 3 comprising a fourth reaction zone connected in series with the third reaction zone and configured to provide a fourth residence time for the reaction mixture passing therethrough at the particular flow rate, wherein the fourth residence time is at least about 1.5 times greater than the third residence time.

7. A reactor according to claim 6 further comprise means for bypassing the fourth reaction zone to reduce the effective residence time of the reaction mixture passing through the reactor.

8. A reactor according to claim 6 wherein the fourth residence time is at least about 2 times greater than the third residence time.

9. A reactor according to claim 1 comprising an nth reaction zone connected in series with an (n−1) th reaction zone and configured to provide an nth residence time for the reaction mixture passing therethrough at the particular flow rate, wherein the nth residence time is at least about 1.5 times greater than the (n−1) th residence time.

10. A reactor according to claim 9 further comprising means for bypassing the nth reaction zone to reduce the effective residence time of the reaction mixture passing through the reactor.

11. A reactor according to claim 9 wherein the nth residence time is at least about 2 times greater than the (n−1) th residence time.

12. A reactor according to claim 1 wherein, when a reaction zone is bypassed, the series connection between the or a preceding reaction zone and the or a following reaction zone is maintained.

13. A reactor according to claim 1 wherein, when a one or more reaction zones are bypassed, a series connection between the remaining (unbypassed) reaction zones is maintained.

14. A reactor according to claim 1 wherein means for bypassing a particular reaction zone comprises a switchable valve situated upstream of an inlet associated with the particular reaction zone.

15. A reactor according to claim 14 wherein the valve has an inlet for incoming reaction mixture, but two outlets and means for switching flow through the valve between the two outlets.

16. A reactor according to claim 15 wherein, when a first outlet is selected, incoming reaction mixture flows through the valve and into the reaction zone inlet.

17. A reactor according to claim 16 wherein, when a second outlet is selected, incoming reaction mixture flows through the valve and into a bypass region, avoiding the reaction zone.

18. A reactor according to claim 17 wherein a second switchable valve is situated downstream of an outlet associated with a particular reaction zone.

19. A reactor according to claim 18 wherein the second valve has an outlet for outgoing reaction mixture, but two inlets and means for switching flow through the valve between the two inlets.

20. A reactor according to claim 19 wherein, when the reaction zone is not bypassed, the second valve is switched to receive reaction mixture from the reaction zone outlet.

21. A reactor according to claim 20 wherein, when the reaction zone is bypassed, the second valve is switched to receive reaction mixture from the bypass region.

22. A reactor according to claim 1 wherein the configuration of each reaction zone to provide different residence times is effected by the bore of reaction tubing within each reaction zone, by the length of such tubing, or by both.

23. A reactor according to claim 22 wherein each reaction zone beyond the first reaction zone comprises tubing inside which a chemical or biological reaction takes place in use of the reactor, the tubing bore being larger than the tubing bore in an immediately preceding reaction zone.

24. A reactor according to claim 22 wherein each reaction zone beyond the first reaction zone comprises tubing inside which a chemical or biological reaction takes place in use of the reactor, the tubing length being larger than the tubing length in an immediately preceding reaction zone.
